(19) United States
(12) Patent Application Publication
(10) Pub. No.: US 2011/0294098 A1
(43) Pub. Date: Dec. 1, 2011

(54) Times Table

(76) Inventors: Willard Lemar Burrell, Davenport, IA (US); Latricia Esperanza Constantino, Davenport, IA (US)

(21) Appl. No.: 12/790,789

(22) Filed: May 28, 2010

(51) Int. Cl. G09B 23/02

(52) U.S. Cl. 434/188

(57) ABSTRACT

Teaching accessories that will help children learn and love arithmetic. Using a table with chips and sectional slots on the table, the child will solve problems by themselves or with others. Starting at a young age will help boost mathematical skills in school, just like learning reading at a young age has helped boost reading skills for children. The parent will select the type of problem the child will solve. The problem is then given and the child will use the chips provided in the corner of the table to solve the problem. The table has ten slots that can hold up to 100 chips on their side alone. The child will move up in skill level and feel accomplishment that will make them want to learn more and do more problems.

### BACKGROUND OF INVENTION

The invention relates to teaching children how to figure mathematics out at a young age by teaching addition, subtraction, division, and multiplication facts making it fun and educational for children to learn, getting them started to great future in arithmetic.

### BRIEF SUMMARY OF THE INVENTION

The Times Table helps parents and children to teach and learn basic arithmetic. By helping children learn mathematics at a young age, it helps them later in school to learn additional math other than basic arithmetic. Just like teaching your children to read at a young age helps them become better students at school and placing them at a higher reading level, learning math will help boost their skills for school. With this table, we can make teaching and learning basic arithmetic fun and educational.

We take basic math and make it fun. Using friends and family to get involved, we get the child interested. Using the chips to share with friends or family members we are teaching division. The child has ten chips to share with one other player we then divide them out evenly we now have five chips each. The child has now completed a division problem. Using the slots provided the child might figure problems out their self without other players at the table. Use the slots for their side or use the whole table keeping the child moving and active. The drawings included show the slots where the children or child can use the chips for the math problem given. The children will feel accomplishment by figuring out the problem by themselves.

### BRIEF DESCRIPTION OF THE DRAWINGS

The Drawings included are FIGS. 1-7.

FIG. 1 is a general view of the top, bottom, and side view;

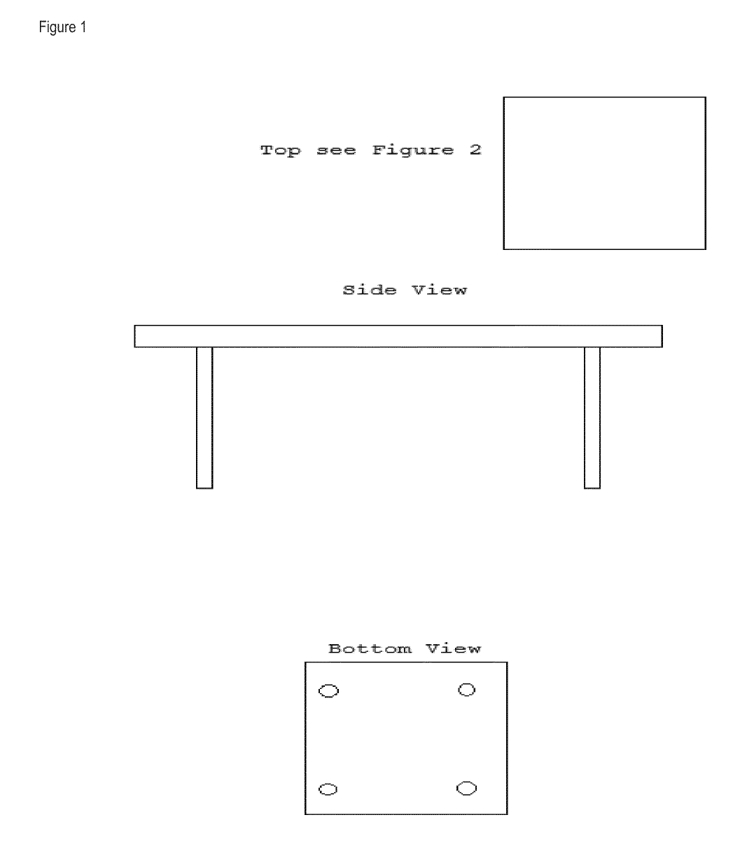

FIG. 2 is a view of the top of the table the slots where the children will place chips when trying to decipher the problem given, and the cups where the chips are stored;

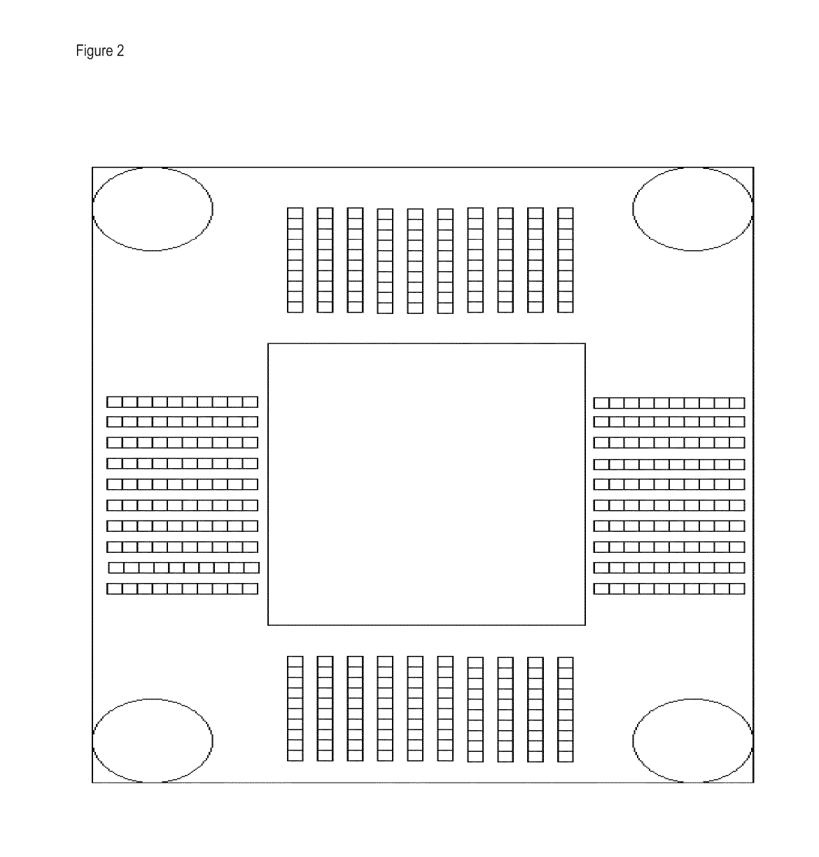

FIG. 3 is the original drawing for the table top;

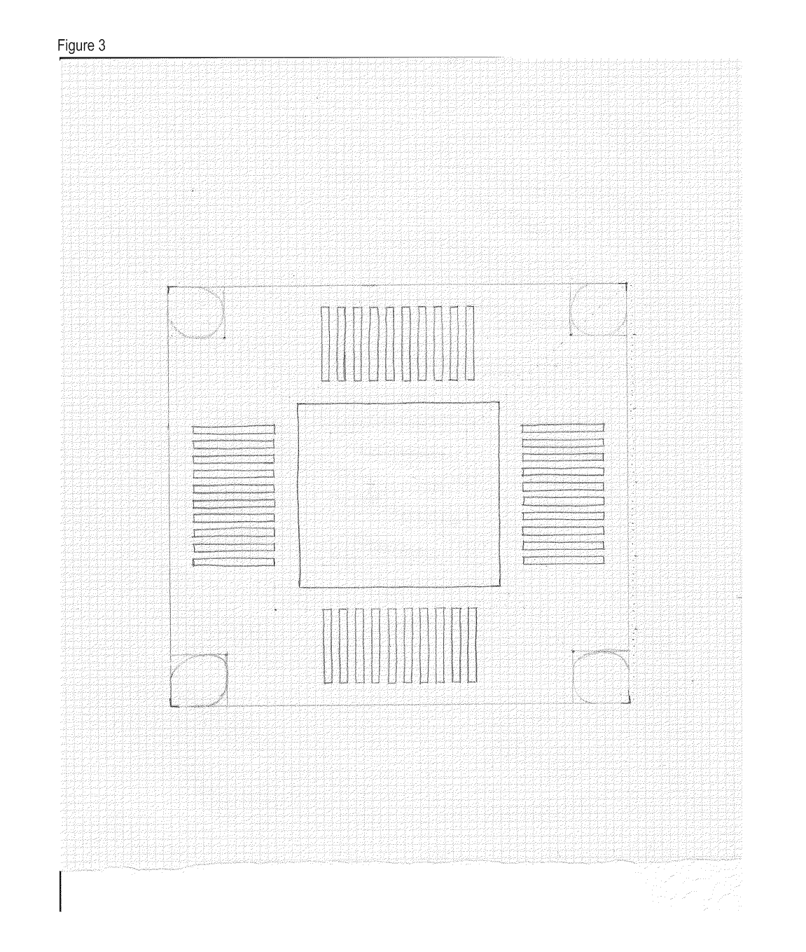

FIG. 4 is an example of an addition problem given in the Detailed Description of the Invention;

FIG. 5 is an example of a subtraction problem given in the Detailed Description of the Invention;

FIG. 6 is an example problem of a division problem given in the Detailed Description of the Invention;

FIG. 7 is an example problem of a multiplication problem given in the Detailed Description of the Invention.

### DETAILED DESCRIPTION OF THE INVENTION

Up to four children can use the table. You may give addition, subtraction, division, and multiplication problems. The parent will choose the problem for the child. The child will use the chips in the provided dish in the corner of the table. The chips will have four different colors to choose from. The child may use the separate color chips to help solve single problems or to use when multiple children are at the table. Each side has ten slots for each player. Each slot holds up to ten chips. The chips are used by placing them in the provided slots to count the correct answer for the problem given. One child can use all four sections for learning by making this a very interactive table. This also may be entered in or used in different languages for easier use. Adults can start using the table with children as young as three years of age (only if there is adult supervision due to small parts).

### EXAMPLE PROBLEMS

Addition: 8+2=?

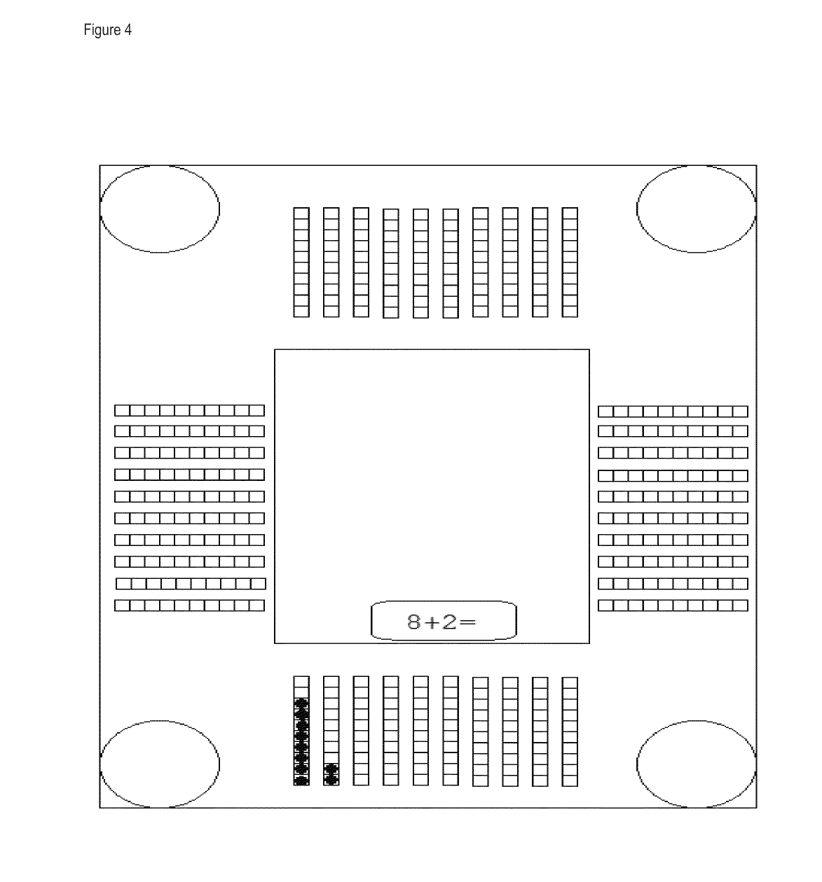

You have the biggest number in your head and the smallest number is added on. Therefore, eight is in your head now adding on two more 9, 10 your answer is 10. Use eight red chips then add two green chips. As shown in FIG. 4.

Subtraction: 10−2=?

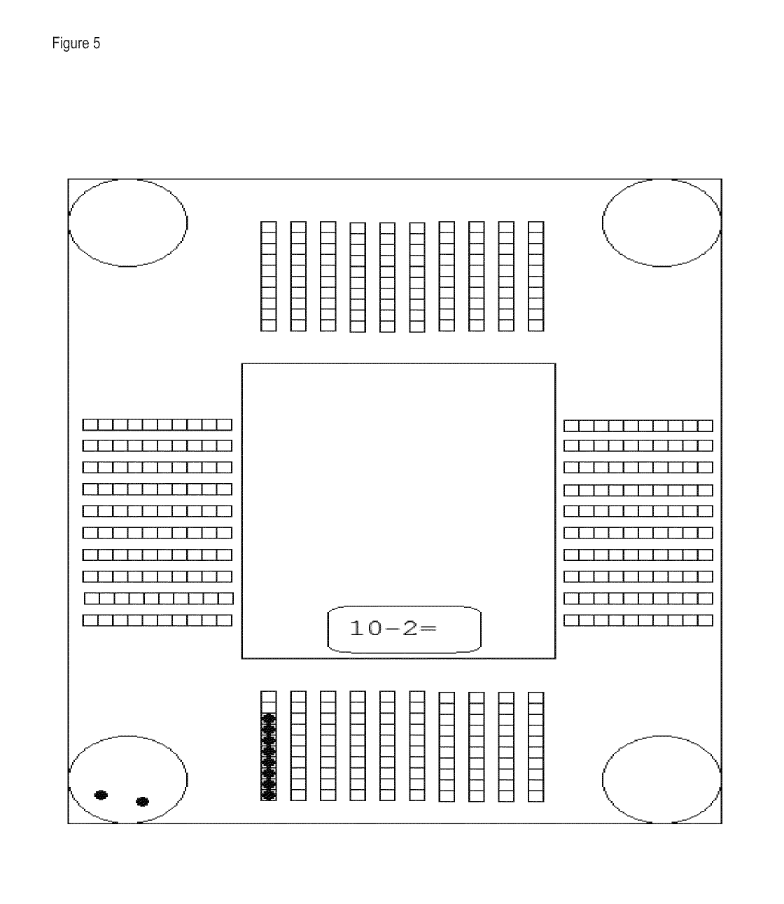

You have ten chips; take two away, now you have eight left. Eight is your answer. As shown in FIG. 5.

Division: 4/4=?

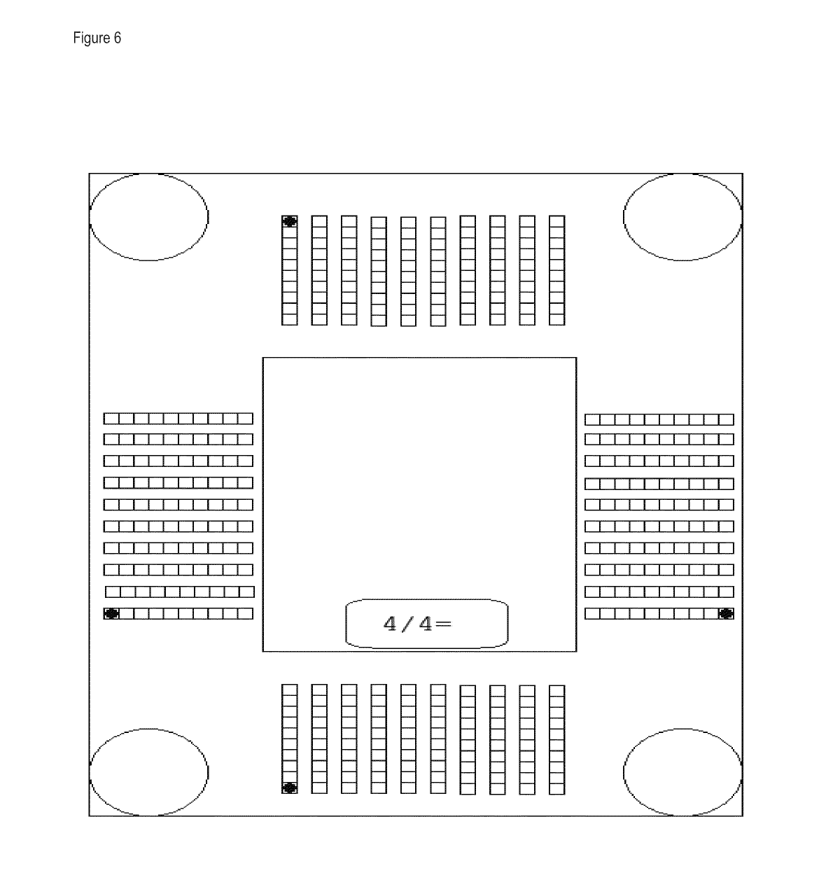

Take four chips of each color or a single color and give you and three other friends' pieces until you have nothing left to pass out. How many pieces did everyone get? One is your answer. As shown in FIG. 6.

Multiplication: 3×2=?

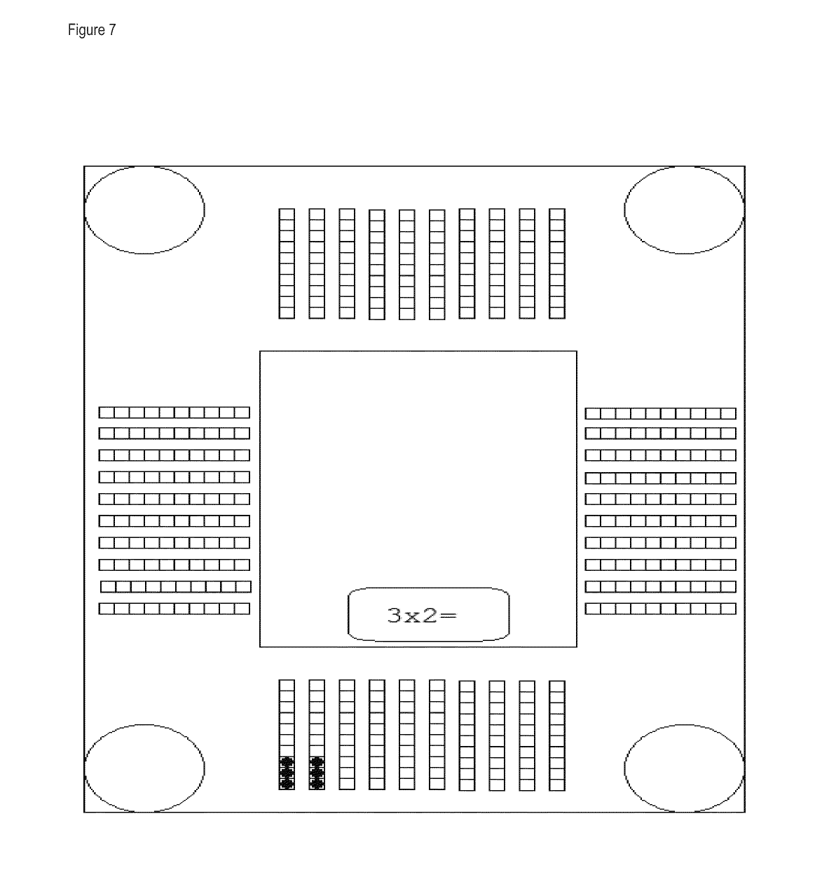

Three is the number needed to be times and two is how many times needed. 3+3=6 so the answer is 6. As shown in FIG. 7.

What is claimed is:

1. A learning device for teaching mathematics to children at a preschool age.

2. Usage of the table with pockets to hold chips in the corner edges of the table.

3. Usage of the table with slots that hold the chips to allow counting to figure out the math problems provided.

4. Usage of chips to help children solve math problems given.
